(19) United States
(12) Patent Application Publication
(10) Pub. No.: US 2020/0185006 A1
(43) Pub. Date: Jun. 11, 2020

(54) SYSTEM AND METHOD FOR PRESENTING A VISUAL INSTRUCTIONAL VIDEO SEQUENCE ACCORDING TO FEATURES OF THE VIDEO SEQUENCE

(71) Applicant: Ran TENE, Tel Aviv (IL)

(72) Inventor: Ran TENE, Tel Aviv (IL)

(21) Appl. No.: 16/693,393

(22) Filed: Nov. 25, 2019

Related U.S. Application Data
(60) Provisional application No. 62/775,960, filed on Dec. 6, 2018.

(51) Int. Cl. G11B 27/031; G06K 9/00; G11B 27/34; G06F 40/289; G09B 19/00

(52) U.S. Cl. CPC G11B 27/031; G06K 9/00744; G06K 9/00765; G09B 5/02; G06F 40/289; G09B 19/003; G11B 27/34

(57) ABSTRACT

A system and a method of segmenting a video sequence and/or presenting a visual instructional video sequence. The method may include: receiving at least one video sequence; extracting at least one feature of the video sequence; segmenting the video sequence according to the at least one extracted feature; and visually presenting the segmented video sequence on a user interface (UI), where the UI may include one or more references to segments of the segmented video sequence.

### PRIOR APPLICATION DATA

The present application claims benefit from prior provisional application 62/775,960, filed on Dec. 6, 2018, entitled “SYSTEM AND METHOD FOR PRESENTING A VIDEO SEQUENCE ACCORDING TO FEATURES OF THE VIDEO SEQUENCE”, incorporated by reference herein in its entirety.

### FIELD OF THE INVENTION

The present invention relates generally to handling of visual instructional video files. More specifically, the present invention relates to extraction of features from a video sequence and presenting the visual instructional video according to the extracted features.

### BACKGROUND OF THE INVENTION

Commercially available video players and video editors provide an ever-expanding variety of features and capabilities for professional and amateur users. At present, users may receive a video sequence, either as streaming video or as a video file, add audiovisual and textual content to the video sequence, and upload the edited video to share with friends and colleagues.

Some commercially available video players further provide artificial intelligence (AI) based capabilities and are adapted to extract data regarding the content of a scene in the video sequence and enable users to view the video sequence according to the extracted data. For example, a video sequence including the sports news may be analyzed by an AI engine, and may be segmented according to scenes (e.g., basketball news, football news, commercials, etc.), and a user may select which scene to view.

Visual instructional videos, such as “How to” videos and Do It Yourself (DIY) videos and physical training videos are a special type of videos that are normally formatted to guide a human viewer through a specific process, including one or more tasks. Such processes may include, for example: creation or building of a product (e.g., building a chair, constructing a wall, etc.), fixing something (e.g., fixing leaking plumbing, fixing a car, etc.), mastering a technique (e.g., painting, throwing clay pottery, etc.), operating a machine (e.g., a lawn mower, etc.) or a software (e.g., producing a desired visual effect on an image processing software, etc.).

Visual instructional videos normally include unique characteristics that may be addressed in a dedicated manner, to optimize a user's viewing experience and allow maximal benefit from using and sharing the visual instructional video. Commercially available video players are not adapted to exploit these unique characteristics and are inadequate in providing such benefits to viewers of visual instructional videos.

### SUMMARY OF THE INVENTION

Embodiments of the present invention are configured to exploit the traits and characteristics of visual instructional videos or movies (e.g., series of still images organized into a movie) to optimize a viewer's experience and provide a plurality of benefits for users thereof.

For example, visual instructional videos commonly include an audiovisual and/or textual description of a process (e.g., baking a cake, instructing a fitness exercise training, etc.) that may include one or more stages (e.g., mixing, baking, etc.). Embodiments may analyze the audiovisual and/or textual description according to these stages, so as to segment or divide the video or movie according to the stages and enable a viewer easy navigation among the stages.

The term ‘segment’ is used herein to refer to a differentiation or division between parts a movie such as a visual instructional video. For example, embodiments may maintain or create timestamps in the playing time of the video as borders between different segments, to form a segmented video sequence. According to context, the term ‘segment’ may further imply division of a movie or video sequence to a plurality of video sequences, and optional storage thereof in different locations in a memory device.

In another example, visual instructional videos may include features that may be associated with each stage, including for example: required materials, required tools, a physical activity performed in the video, etc.

Embodiments of the invention may analyze the audiovisual and/or textual content or description of the instructional video, so as to segment the video according to these features. Embodiments of the invention may subsequently facilitate easy navigation through the video sequence, by a graphical or visual interface. For example, in an example of a workout video, embodiments of the invention may segment the workout video according to stages or types of exercises demonstrated in the video (e.g., push-ups, sit-ups, etc.). These segments may subsequently be represented to a user on a User Interface (UI) such as a screen or a monitor of a computing device of the user. For example, the segments may be represented as a set or a plurality of screen-capture icons or thumbnail images, where each icon or thumbnail may include a representation of a frame in the segmented video, and where the set of icons represents a respective portion (e.g., the entirety) of the segmented video. For example, a first thumbnail may include an image of a push-up exercise, a second thumbnail may include an image of a sit-up exercise, etc. Embodiments may enable the user to navigate through the segmented video, e.g., by receiving an indication of the user selecting a specific segment (e.g., receiving an indication that the user has clicked or selected a thumbnail or icon), and playing the segment corresponding to the received indication (e.g., corresponding to the user's selection).

Additionally, or alternatively, embodiments of the invention may present a video sequence (e.g., by the UI) to a user, and may receive (e.g., from a user, via the UI) an indication or a requirement for segmentation of the video. Pertaining to the example of the physical training video, a user may view a video that may be segmented (e.g., to a plurality of segments) or unsegmented (e.g., included in a single segment). A user may choose to mark or indicate a specific point in the video sequence (e.g., by selecting a specific point in a timeline or time bar (e.g., element 210-D of FIG. 6A) of the presented video sequence, as known in the art). Embodiments of the invention may thus segment the video at the indicated point and may facilitate easy navigation through the video sequence by the UI (e.g., by selecting a thumbnail corresponding to the newly created segment), as elaborated above.

Some embodiments may provide a bird's-eye overview of a movie and natural sections of the movie, such as a process described in the visual instructional video (e.g., a DIY video, a physical training video, and the like), to graphically or visually present different features, tasks and/or stages that may be included in the movie or instructional video. This bird's-eye overview of the entire process may, for example:

Enable a user to navigate through the visual instructional video according to the extracted features and/or stages of the instructional process, as elaborated herein. For example, embodiments of the invention may display, on a UI, screenshot thumbnails or icons that may represent segments of the segmented video, and may display or play the video following selection or ‘clicking’ of a thumbnail or icon (e.g., by a user, via the UI);

Enable a user to manipulate the segmented video in a segment resolution (including for example: cutting, copying and/or pasting at least one segment or section to or from the segmented video sequence), as elaborated herein;

Enable a user to evaluate, at a first glance, whether the instructed process is suitable for their needs (e.g., whether he or she may have sufficient time or tools to perform all the tasks included in the process conveyed by the visual instructional video). For example, as elaborated herein, embodiments of the invention may display, on a UI, graphical elements (e.g., elements 210-B1, 210-B2, 210-B3 of FIG. 6A) such as screenshot thumbnails or icons that may represent segments of the segmented video. For example, embodiments of the invention may segment a DIY video according to the tools (e.g., hammer, drill, paintbrush) used therein, and may subsequently display screenshot thumbnails or icons according to these segments (e.g., a first thumbnail image of a person using a hammer, a second thumbnail image of a person using a drill, etc.). A user may thus easily determine, at first glance (e.g., as part of a search process on the internet), whether the video accommodates their needs, expectations or expertise. For example, a child may easily determine (e.g., by viewing the thumbnails) that a DIY video that includes usage of a power tool (e.g., a drill) may not be suitable (e.g., dangerous) for them to follow; and

Enable a user to share the segmented video among a plurality of other users and/or computing devices, enabling other users to perform actions such as viewing, commenting on, and saving of one or more segments of the segmented video.

Embodiments may allow a group of two or more users to collaborate through the bird's-eye overview by: producing comments that are linked to specific segments of the video sequence; sharing their comments among a plurality of computing devices; and presenting, on each of the plurality of computing devices an association of each user's comment(s) with specific video sequences, to clarify a context of one or more specific comment(s).

It may be noted that embodiments of the invention may facilitate collaboration among a plurality of users in relation to data elements that may be unrelated to segmented video sequences. For example, embodiments may allow a group of two or more users to collaborate through a public bird's-eye overview by: sharing one or more data elements (e.g., images, data files, etc.) that may not be related to segments of a segmented video; producing comments that may be linked to the one or more data elements; sharing their comments among a plurality of computing devices; and presenting, on each of the plurality of computing devices an association of each user's comment(s) with specific data elements, to clarify a context of one or more specific comment(s).

In another example, instructional videos may be related to real-time occurrences (e.g., baking a cake, instructing a fitness exercise, etc.), having a real-time timescale (e.g., having in the oven for an hour). Embodiments may include reference to such a real-time timescale, including for example a length of a task, to inform a viewer how much time at least one task should normally take, as elaborated herein.

In another example, tasks that are included in a visual instructional video may be of different levels of difficulty. For example, a task involving lighting a match may not be suitable for small children. Embodiments may include reference to the ease or difficulty of at least one task that may be included in the video sequence, as elaborated herein.

In another example, viewers that may use a visual instructional video may require a dedicated platform for sharing their ideas, thoughts and questions regarding each of the features described above (e.g., scenes, tools, tasks, etc.). Embodiments may include a UI that may facilitate easy, graphical referral of users to specific such features in the visual instructional video sequence, as elaborated herein.

Embodiments of the invention may include a method of segmenting a video sequence and/or visually presenting a visual instructional video by at least one processor. Embodiments of the method may include: receiving at least one video sequence; extracting at least one feature of the video sequence; segmenting the video sequence according to the at least one extracted feature; and visually presenting the segmented video sequence on a user interface (UI), where the UI may include one or more references to segments of the segmented video sequence.

According to some embodiments, the video sequence may include one or more phrases, and the method may include: obtaining a textual format of at least one phrase in the video sequence and segmenting the video sequence according to the obtained textual format of the one or more phrases.

According to some embodiments, the phrase may be a spoken phrase and the method may include: receiving at least one criterion for segmenting the video sequence; training a natural language processing (NLP) machine-learning (ML) model to determine at least one segmentation point in the video sequence according to the at least one received criterion and the textual format of at least one phrase in the video sequence; and segmenting the video sequence and/or visually presenting the visual instructional video according to the determined segmentation point(s).

As elaborated herein, embodiments may use a ML or NLP component to identify or extract at least one feature of the video sequence, and optionally set a segmentation point around the time of appearance of the extracted feature in the video. Such a component may be a neural network (NN). A NN may refer to an information processing paradigm that may include nodes, referred to as neurons, organized into layers, with links between the neurons. The links may transfer signals between neurons and may be associated with weights. A NN may be configured or trained for a specific task, e.g., pattern recognition or classification. Training a NN for the specific task may involve adjusting these weights based on examples. Each neuron of an intermediate or last layer may receive an input signal, e.g., a weighted sum of output signals from other neurons, and may process the input signal using a linear or nonlinear function (e.g., an activation function). The results of the input and intermediate layers may be transferred to other neurons and the results of the output layer may be provided as the output of the NN. Typically, the neurons and links within a NN are represented by mathematical constructs, such as activation functions and matrices of data elements and weights. A processor, e.g. CPUs or graphics processing units (GPUs), or a dedicated hardware device may perform the relevant calculations.

Embodiments of the invention may include: training an object-detection ML model to identify one or more objects in the video sequence; determining at least one segmentation point according to the identified object and the at least one received criterion; and segmenting the video sequence and/or visually presenting the visual instructional video according to the determined at least one segmentation point.

Embodiments of the invention may include: producing on a first computing system, a scheme associated with at least one data element; exporting the scheme to a second computing system; and displaying the data element on a UI on the second computing system according to the scheme.

The data element may be selected from a list including a video file, a segmented video, a segment of a segmented video, a data file, a text file, an image file and an audio file.

The scheme may include at least one of: a pointer to a storage of the data element and a graphic representation of the data element.

According to some embodiments, the UI may include: a first panel, including at least one video player window; and a second panel, including at least one thumbnail referring to a respective segment of the segmented video, where clicking the at least one thumbnail may cause the video player to start displaying the segmented video at the respective segment.

The UI may include at least one of: a first timescale or time bar, associated with the time lapse of a video sequence in the at least one video player and a second time bar associated with real-world time lapse.

The UI may include a correspondence panel, that may include at least one of: a correspondence message received from one or more users and a textual comment.

At least one correspondence message or comment may relate to at least one data element, and the correspondence panel may include a graphical association of the message or comment to a graphical representation of the related data element.

Embodiments of the present invention may include a system for segmenting a video file and/or visually presenting the visual instructional video file. The system may include: a non-transitory memory device, where modules of instruction code are stored, and a processor associated with the memory device, and configured to execute the modules of instruction code. Upon execution of the modules of instruction code, the processor may be configured to: receive at least one video file; extract at least one feature of the video file; segment the video file according to the at least one extracted feature; and present the segmented video on a user interface where in the user interface comprises one or more references to segments of the segmented video.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram, depicting a computing device which may be included in a system for presenting a video according to extracted video features, according to some embodiments;

FIG. 2 is a block diagram, depicting a schematic workflow that may be implemented by a system for presenting a video according to extracted video features, according to some embodiments; and

FIG. 3 is a block diagram, depicting a system for presenting a video according to extracted video features, according to some embodiments;

FIG. 4 is a block diagram, depicting an editor module that may be included in a system for presenting a video according to extracted video features, according to some embodiments;

FIG. 5 is a block diagram, depicting a player module that may be included in a system for presenting a video according to extracted video features, according to some embodiments;

FIG. 6A is a block diagram, schematically depicting a user interface on the player side, which may be included in a system for presenting a video according to extracted video features, according to some embodiments;

FIG. 6B and FIG. 6C are examples of screen shots of a user interface that may be included in a system for presenting a video according to extracted video features, and as implemented on a computing device; and

FIG. 7 is a flow diagram depicting stages of a method for presenting a video according to extracted video features, according to some embodiments.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

Embodiments of the present invention disclose a method and a system for presenting a video according to features, such as extracted video features.

The following table, Table 1, may serve as a reference for terms that may be used herein

TABLE 1

| | |
|---|---|
| Video sequence | The term “video sequence” or “video” is used herein to refer to at |
| | least one data structure that may include video data in any |
| | appropriate format. Embodiments may receive a video sequence, |
| | for example as a video file or as streaming data, and may be |
| | configured to perform operations on the received video sequence |
| | as elaborated herein. A video sequence may be considered to be |
| | a discrete coherent portion of a video or movie, e.g. a certain |
| | movie scene, a certain operation in a sequence of operations, etc. |
| | and may include a series of still images typically displayed at a |
| | speed (e.g. 30 frames per second) perceived by a viewer as a |
| | moving image. |
| | The term video sequence may, according to context, refer only to |
| | video data (e.g., a sequence of moving images), or to audiovisual |
| | data that may also including data related to sound, text and the |
| | like. |
| Timestamp | The term ‘timestamp’ is used herein to refer to a numerical |
| | representation of a time within a video sequence. A timestamp |
| | may relate to a video sequence's playing time (e.g., time that has |
| | elapsed since the beginning of video sequence) or a time that has |
| | elapsed in the real world, according to context. |
| Segmentation point | The term “segmentation point” is used herein to refer to a |
| | timestamp or other indicator of a point within a video sequence |
| | that may be produced by embodiments of the invention, to cut, |
| | divide or segment an input video sequence into a plurality of |
| | segments or sections according to at least one segmentation |
| | criterion. |
| Segmentation | The term “segmentation criterion” is used herein to refer to a |
| criterion | criterion, that may be predefined (e.g., by a user) to segment an |
| | input video sequence, including for example: segmentation |
| | according to a change of scenes, according to stages or tasks |
| | included in the video sequence, according to tools, objects or |
| | materials that appear in the video, and the like. |
| Feature or | The term ‘feature’ or “segmentation feature” is used herein to refer |
| segmentation feature | to an element that may be included in (e.g. as an image or portion |
| | of an image) the video sequence and may relate to at least one |
| | respective segmentation criterion. According to some |
| | embodiments, the feature, or segmentation feature may appear in |
| | a single (e.g., still) video frame. Additionally, or alternatively, the |
| | feature, or segmentation feature may appear across more than one |
| | frame in a moving image. |
| | For example, a segmentation criterion of segmenting according |
| | to objects that appear in the video may relate to features such as |
| | a first object (e.g., a hammer) that may be identified in the video |
| | sequence and second object (e.g., a saw) that may be pronounced |
| | as part of a spoken phrase in the video. The term feature may refer |
| | both to the actual object (e.g. a tool, a person) and to the image |
| | representation of the object in one or more image frames. |
| Segmented video | The term “segmented video sequence” is used herein to refer to a |
| sequence | data structure that may include at least one video sequence, and |
| | one or more timestamps or segmentation points, marking a border |
| | or separation between segments. Alternately, or additionally, |
| | segmented video sequence may refer, according to context, to a |
| | data structure that may include one or more separate video |
| | sequences and/or pointers thereto. |
| Phrase | The term ‘phrase’ is used herein is used herein to refer to at least |
| | one word, either spoken or written in the video sequence. For |
| | example, a video sequence may have associated or integrated |
| | with it an audio track or recording, or text (e.g. closed captioning) |
| | which may include phrases. |

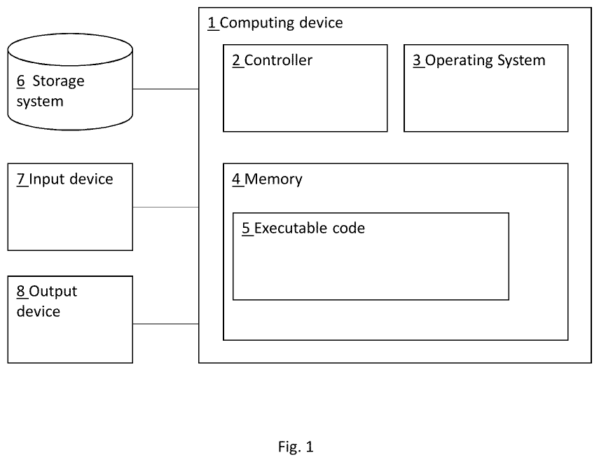

Reference is now made to FIG. 1, which is a block diagram depicting a computing device, which may be included within an embodiment of a system for presenting a video according to extracted video features, according to some embodiments.

Computing device 1 may include a controller 2 that may be, for example, a central processing unit (CPU) processor, a chip or any suitable computing or computational device, an operating system 3, a memory 4, executable code 5, a storage system 6, input devices 7 and output devices 8. Controller 2 (or one or more controllers or processors, possibly across multiple units or devices) may be configured to carry out methods described herein, and/or to execute or act as the various modules, units, etc. More than one computing device 1 may be included in, and one or more computing devices 100 may act as the components of, a system according to embodiments of the invention.

Operating system 3 may be or may include any code segment (e.g., one similar to executable code 5 described herein) designed and/or configured to perform tasks involving coordination, scheduling, arbitration, supervising, controlling or otherwise managing operation of computing device 1, for example, scheduling execution of software programs or tasks or enabling software programs or other modules or units to communicate. Operating system 3 may be a commercial operating system. It will be noted that an operating system 3 may be an optional component, e.g., in some embodiments, a system may include a computing device that does not require or include an operating system 3.

Memory 4 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 4 may be or may include a plurality of, possibly different memory units. Memory 4 may be a computer or processor non-transitory readable medium, or a computer non-transitory storage medium, e.g., a RAM.

Executable code 5 may be any executable code, e.g., an application, a program, a process, task or script. Executable code 5 may be executed by controller 2 possibly under control of operating system 3. For example, executable code 5 may be an application that may present a video according to extracted video features as further described herein. Although, for the sake of clarity, a single item of executable code 5 is shown in FIG. 1, a system according to some embodiments of the invention may include a plurality of executable code segments similar to executable code 5 that may be loaded into memory 4 and cause controller 2 to carry out methods described herein.

Storage system 6 may be or may include, for example, a flash memory as known in the art, a memory that is internal to, or embedded in, a micro controller or chip as known in the art, a hard disk drive, a CD-Recordable (CD-R) drive, a Blu-ray disk (BD), a universal serial bus (USB) device or other suitable removable and/or fixed storage unit. Content may be stored in storage system 6 and may be loaded from storage system 6 into memory 120 where it may be processed by controller 2. In some embodiments, some of the components shown in FIG. 1 may be omitted. For example, memory 4 may be a non-volatile memory having the storage capacity of storage system 6. Accordingly, although shown as a separate component, storage system 6 may be embedded or included in memory 4.

Input devices 7 may be or may include any suitable input devices, components or systems, e.g., a detachable keyboard or keypad, a mouse and the like. Output devices 8 may include one or more (possibly detachable) displays or monitors, speakers and/or any other suitable output devices. Any applicable input/output (I/O) devices may be connected to Computing device 1 as shown by blocks 7 and 8. For example, a wired or wireless network interface card (NIC), a universal serial bus (USB) device or external hard drive may be included in input devices 7 and/or output devices 8. It will be recognized that any suitable number of input devices 7 and output device 8 may be operatively connected to Computing device 1 as shown by blocks 7 and 8.

A system according to some embodiments of the invention may include components such as, but not limited to, a plurality of central processing units (CPU) or any other suitable multi-purpose or specific processors or controllers (e.g., controllers similar to controller 2), a plurality of input units, a plurality of output units, a plurality of memory units, and a plurality of storage units.

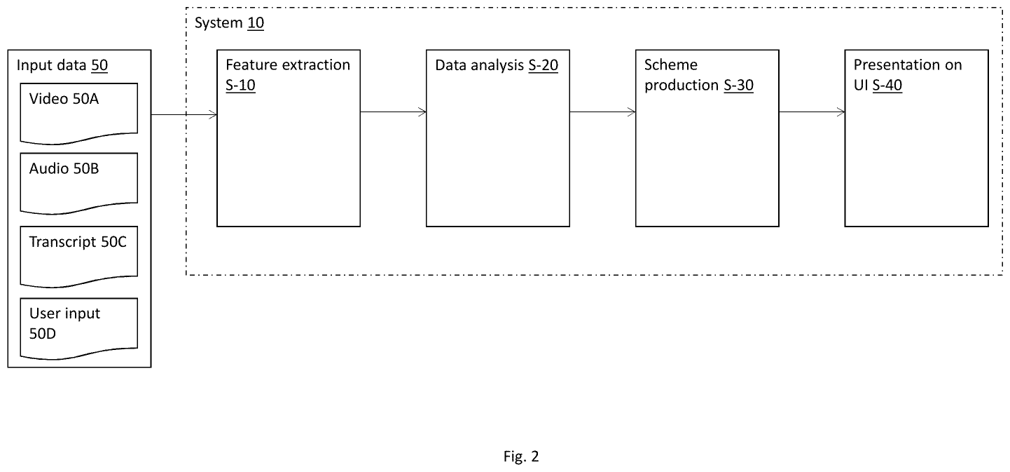

Reference is now made to FIG. 2, which is a block diagram depicting a schematic workflow that may be implemented by a system 10 for presenting a video according to extracted video features, according to some embodiments.

System 10 may be or may include a computing device (e.g., element 1 of FIG. 1), such as a desktop computer, laptop computer, a tablet computer, a smartphone and the like. System 10 may include a non-transitory memory device (e.g., element 4 of FIG. 1), where modules of instruction code are stored, and a processor (e.g., element 2 of FIG. 1) associated with the memory device and configured to execute the modules of instruction code. The processor 2 may be configured, upon execution of the modules of instruction code, to perform at least one method of extracting features from a video sequence and presenting the video according to the extracted features.

As shown in FIG. 2, system 10 may receive at least one element of input data 50 and perform at least one action thereupon.

The at least one element of input data 50 may include, for example: a movie or video sequence 50A, including a video file and/or a video stream (e.g. sequence of still images) of any known video format; an audio sequence 50B that may be or may not be included within or associated with the video sequence 50A; a transcript 50C that may be or may not be included within the video sequence 50A and may include at least one textual data element associated with the at least one audio sequence 50A (e.g., a written version of audio sequence 50A); and a user data input 50D that may be associated with at least one video sequence, including for example: textual data, such as text that would be displayed on a video player and informative data, such as data relating to tasks and/or scenes in the video sequence.

System 10 may perform at least one action on the input data, including for example: extraction of features S-10, data analysis S-20, scheme production S-30 and presentation on a user interface (UI) S-40.

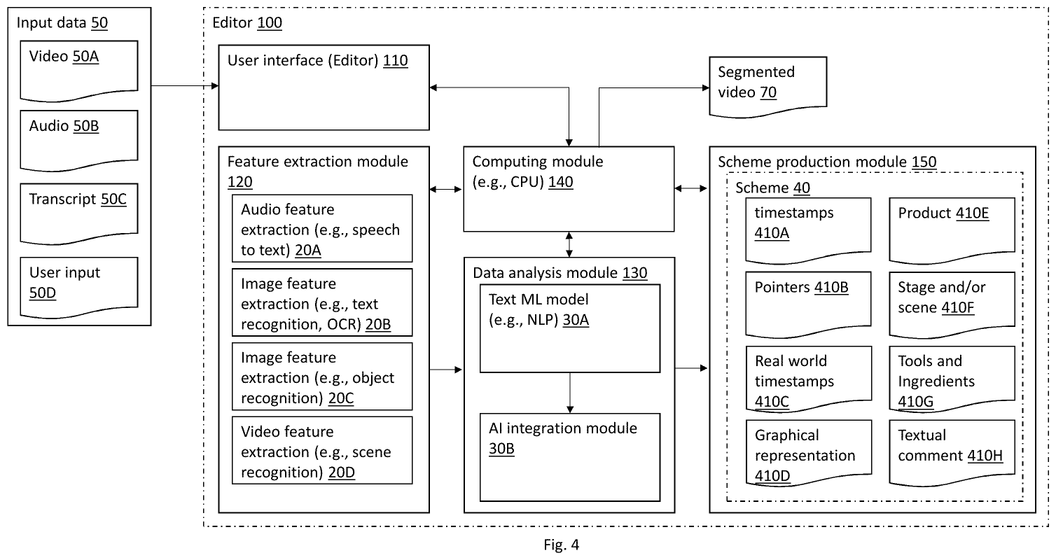

The extraction of features S-10 from the input data may include, for example: identifying at least one object in the video sequence, identifying at least one scene of the video sequence, identifying at least one spoken phrase in the audio sequence, etc. as elaborated herein, e.g., in relation to FIG. 4.

The analysis of data S-20 of the extracted features may include for example: division or segmentation of the video or video sequence according to scenes, according to spoken phrases and according to user input data 50D, etc. as elaborated herein, e.g., in relation to FIG. 4.

Scheme production S-30 may include aggregating the analyzed data and sorting it in a data structure, hereinafter referred to as a scheme, that may be transferable between different instantiations of system 10 (e.g., on different computing devices 1), as elaborated herein, e.g., in relation to FIG. 4.

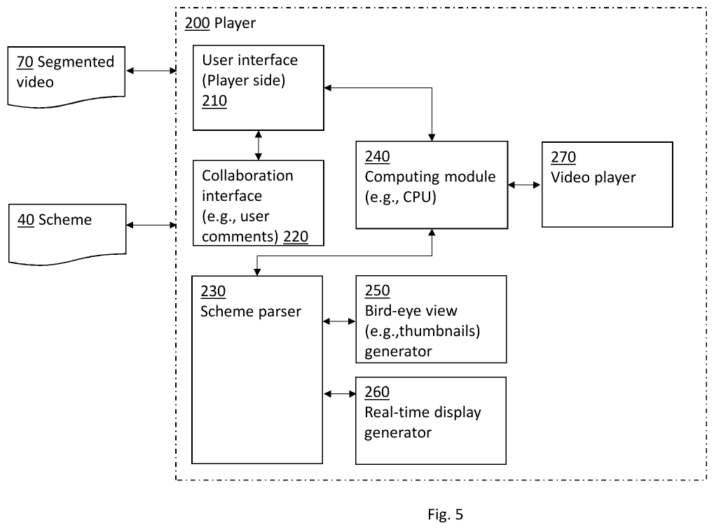

Presentation on a UI S-40 may include visually presenting the video segment on a UI according to the produced scheme, as elaborated herein in relation to FIG. 5.

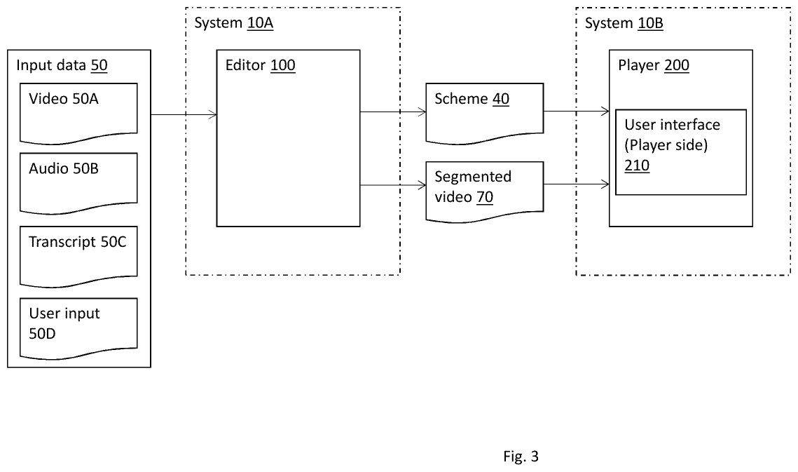

Reference is now made to FIG. 3, which is a block diagram depicting a system 10 (e.g., 10A, 10B) for visually presenting a video according to extracted video features, according to some embodiments.

As shown in FIG. 3, a first system 10 (e.g., 10A) may include an editor 100 module, configured to perform at least one of: feature extraction (e.g., element S-10 of FIG. 2), data analysis (e.g., element S-20 of FIG. 2) and scheme production (e.g., element S-30 of FIG. 2). A second system 10 (e.g., 10B) may include a player module 200, configured to receive the produced scheme 40 and present the video sequence on a UI, according to scheme 40.

In some embodiments, system 10A and system 10B may be separate entities (e.g., separate software processes implemented on separate computing devices 1), and may be communicatively connected (e.g., over a computer network) to transfer at least scheme 40 therebetween.

Such embodiments may, for example, match or detect a condition in which a first user of system 10A may produce a video sequence (e.g., an ice-cream preparation video), and may provide user information (e.g., via user input 50D) regarding at least one process or task described in the video (e.g., a duration each task, such as preparing a mixture, churning, freezing, etc.), and at least one second user may view the video according to scheme 40, comment, mark and share specific elements associated with the video via their UI.

Alternately, system 10A and system 10B may be implemented as the same entity (e.g., a single software entity implemented on a single computing device 1), and scheme 40 may be transferred between editor 100 and player 200 by internal communication (e.g., via inter-process communication, as known in the art).

Such an embodiment may, for example, match or detect a condition in which the first user may edit the video sequence and/or add additional relevant information (e.g., add an audio sequence 50B), and may wish to review the outcome of his or her actions on the UI during the process of editing.

According to some embodiments, editor 110 may be configured to receive at least one video sequence and identify and extract at least one feature of the at least one video sequence. For example, a video sequence may include an instructional audible explanation, such as an explanation for a carpentry job (e.g., building a chair). Editor 110 may include a speech to text module, adapted to transfer the audible explanation information into textual format, and a Natural Language Processing (NLP) module, configured to identify phrases and words within the text. Editor 110 may thereby detect when the explanation refers to a first feature (e.g., a first carpentry tool, such as a saw) and when the explanation refers to a second feature (e.g., a second carpentry tool, such as a hammer).

Editor 110 may divide segment the video sequence according to at least one feature, such as an extracted feature. For example, editor 110 may produce timestamps relating to the playing time of the video sequence, associating each extracted feature with a specific playing time or timestamp. Pertaining to the saw and hammer example above, editor 110 may mark when a saw is used and when a hammer is used and segment the video sequence accordingly (e.g., to a first scene, in which a saw is used and a second scene in which a hammer is used) as elaborated below.

Player 200 may present the segmented video sequence on a user interface (UI 210). For example, UI 210 may include a video player window as known in the art and a reference panel, including one or more graphical references or pointers (e.g., thumbnails, icons and the like) to or associated with segments or sections of the segmented video sequence. Player 200 may enable a human viewer to click on or select at least one such reference or pointer, and may consequently play (e.g. display as a moving image) the respective selected segments of the segmented video sequence

In some embodiments, editor 110 may store (e.g., in storage module 6 of FIG. 1, on an online storage server, and the like) the segments as separate video sequences and produce a scheme 40 that may include at least one reference or pointer to at least one stored segment. In such embodiments, when a user clicks or selects at least one reference or pointer thumbnail on UI 210, UI 210 may present the selected video segment by addressing and reading the content of the location of the stored segment.

Alternately or additionally, editor 110 may produce a scheme 40, that may include at least one timestamp or other video location marker of a difference between segments of the video (e.g., the time or point at which an instructor began using the saw or the hammer). In such embodiments, when a user clicks or selects at least one reference or pointer thumbnail on UI 210, UI 210 may be adapted to promote the playing time of the segmented video sequence so as to present the video from the respective time.

Reference is now made to FIG. 4, which is a block diagram depicting an editor module 100 that may be included in a system for presenting a video according to extracted video features, according to some embodiments. As shown in FIG. 4, editor module 100 may be or may include at least one computing module 140, configured to execute at least one operation of editor module 100, as described herein. In some embodiments, computing module 140 may be implemented as a computing device 1, as elaborated above in relation to FIG. 1.

As elaborated above, input data 50 may include a visual instructional video sequence 50A. Video sequence 50A may include or may be associated with one or more additional inputs, including an audio sequence 50B, a transcript text 50C, and user input 50D (e.g., data including a text element that should be presented in the video at a specific playing time and a specific location on the screen).

In some embodiments, user input 50D may include at least one setting of editor 100. For example, editor 100 may include a UI 110 (e.g., a graphical user interface) that may enable a user to apply the settings according to their preference.

In some embodiments, user settings of editor 100 may include a definition of at least one segmentation criterion, and/or at least one segmentation feature according to which editor 100 may perform segmentation of the visual instructional video sequence, to produce a segmented video.

For example, a segmentation criterion may be segmentation of the video according to stages or tasks included in the description conveyed by the visual instructional video. For example, a process of building a table may be segmented to: (a) preparing the legs, (b) preparing the surface, (c) constructing the table, and (d) painting the table. Respective one or more features may be object(s) that may be recognized in the video sequence by editor 100, as pertaining to a context of at least one stage. Pertaining to the table example, these features may include, for example objects identified as a saw, a hammer and a paint bucket.

In another example, a segmentation criterion may be segmentation of the video according to materials or tools used in the process. For example, a process of preparing a printed circuit board (PCB) may be segmented according to the usage of electronic components, wires, a cutter and a soldering iron. Respective one or more features or segmentation features may, for example, be object(s) that may be recognized in the audio stream 50B and/or in a text included in user input 50D. Pertaining to the PCB example, these features may include identification of a spoken or textual phrase, that may include words such as: wire, cutter and soldering iron.

As shown on FIG. 4, editor module 100 may include a feature extraction module 120, configured to extract at least one feature included in or associated with input data 50.

Feature extraction module 120 may include an audio feature extraction module 20A, configured to extract at least one feature from audio sequence 50B, that may be included in or associated with video sequence 50A. In some embodiments, audio sequence 50B may include or be associated with at least one spoken phrase (e.g., a sentence or a word spoken by a person that appears in the visual instructional video).

Audio feature extraction module 20A may include a speech to text engine, configured to obtain a textual format of at least one phrase in the video sequence, as known in the art. Alternately, or additionally, input data 50 may include a transcript 50C e.g., a textual format of at least one phrase in the audio sequence 50B. Editor 100 may then segment video sequence 50A according to the obtained textual format of the one or more phrases as elaborated below.

Pertaining to the example of a visual instructional video for preparing a PCB, audio feature extraction module 20A may obtain a textual format of the words spoken in the video. Editor 100 may then identify specific extracted features (e.g., the word ‘cutter’), in the textual format and mark the timing, e.g., produce a timestamp marking the appearance of the feature (e.g., the word ‘cutter’) in the playing time of the video.

Editor 100 may maintain (e.g., in storage element 6 of FIG. 1) a table, associating at least one extracted feature with the timestamp of appearance of that feature in audio sequence 50B (e.g., the playing time at with the phrase or word ‘cutter’ was spoken).

As explained above, video sequence 50A may include or be associated with audio sequence 50B. For example, audio sequence may include an audio stream that may be played in synchronicity with video sequence 50A, as known in the art. Hence, the timestamp or mark may be regarded as limits or borders between sections or segments of video sequence 50A, thus editor 100 may segment the video sequence 50A according to the obtained textual format of the one or more spoken phrases.

In some embodiments, audio feature extraction module 20A may be configured to extract at least one feature that may not be related to a spoken phrase. For example, audio feature extraction module 20A may include at least one Machine-Learning (ML) model configured to identify at least one noise in audio sequence 50B. Pertaining to the example of building a table, the ML model may be trained to identify a noise that may be produced by a saw or a hammer.

In some embodiments, the video sequence 50A may include a textual phrase, including for example a sign (e.g., a road sign) or a label (e.g., a label on a product) that may be pictured or photographed as part of the video sequence, a textual subtitle that may have been added to the video and the like. Feature extraction module 120 may include a text recognition module 20B, configured to extract at least one textual feature therefrom. For example, text recognition module 20B may include an optical character recognition (OCR) engine, configured to identify at least one pictured textual phrase (e.g., a word or a sentence that may be included within video sequence 50A), and obtain a textual format of the pictured phrase.

In a similar manner to that described above in relation to a spoken phrase, editor 100 may maintain a table (e.g., in storage element 6 of FIG. 1), associating at least one extracted feature (e.g., a textual format of a pictured phrase) with the appearance of the pictured phrase in video sequence 50A and segment video sequence 50A accordingly.

According to some embodiments, editor 100 may include at least one ML-based Natural Language Processing (NLP) module 30A. NLP module 30A may receive at least one criterion for segmenting the video sequence and at least one phrase in a textual format (e.g., from transcript input 50C, from user input 50D, from speech to text module 20A and from OCR module 20B, as described above) and may be trained to determine or produce at least one segmentation point according to at least one segmentation criterion.

Pertaining to the example of segmenting the table-building visual instructional video according to stages in the process, NLP module 30A may receive (e.g., from element 6 of FIG. 1) a plurality of features and respective timestamps. Such features may include, for example: a first feature (e.g.: spoken phrase, such as a sentence from speech to text module 20A, including the words: “at this stage we will saw the legs”), associated with a first timestamp; and a second feature (e.g., a textual format of a pictured phrase such as “red paint” on a paint box from OCR module 20B), associated with a second timestamp, etc.

NLP 30A may be trained, as known in the art, to understand a context in which the text features have been received in relation to at least one predefined criterion, to determine the context at each moment of video stream 50A. For example, NLP 30A may be trained to determine at least one segmentation point in the video sequence according to a received criterion and a textual format a phrase in the video sequence. Pertaining to the table example, NLP 30A may be trained determine that a context of each extracted feature in relation to the stage of the table-building process (e.g., when the legs is prepared, when the surface is prepared, etc.) at each moment (e.g., at each timestamp).

NLP 30A may identify at least one point in the video playing time that the context has changed (e.g., when a stage ends and the table video turns from preparing the legs to the surface), and subsequently produce at least one timestamp or segmentation point, marking that change. Editor 100 may subsequently segment video sequence 50A according to the at least one segmentation point as elaborated herein.

In some embodiments, the video sequence 50A may include one or more pictured objects. Feature extraction module 120 may include an ML-based object recognition module 20C. Module 20C may include an object-detection ML model, trained to identify at least one pictured object from video sequence 50A, as known in the art.

According to some embodiments of the invention, editor 100 may determine at least one segmentation point according to the identified object and at least one segmentation criterion and may segment video sequence 50A according to the determined at least one segmentation point. Additionally, or alternatively, editor 100 may receive (e.g., via UI 110, via user input 50D) at least one indication or request (e.g., from a user) to segment the video sequence at a specific time in the video. Editor 100 may add or set a segmentation point at the specific time in the video according to the request and may segment the video sequence according to the added segmentation point.

Pertaining to the example of a visual instructional video for building a table:

User input 50D may include at least one setting that may define a segmentation criterion as segmenting the video stream according to appearance of objects;

User input 50D may include at least one setting that may define a hammer as a feature for segmentation (e.g., to segment the video according to appearance of a hammer therein);

ML-based object recognition module 20C may be trained to identify working tools (e.g., a screwdriver, a ratchet, a hammer, a saw, etc.);

ML-based object recognition module 20C may extract a specific feature in video sequence 50A, such as appearance of a pictured object (e.g., a hammer) at a specific moment of video sequence 50A playing time; and

Editor 100 may maintain (e.g., in storage element 6 of FIG. 1) a table, associating at least one extracted feature (e.g., appearance of hammer) with the timestamp of appearance of that feature in video sequence 50A. Editor 100 may relate to these timestamps as segmentation points or borders between segments of video sequence 50A, and segment video sequence 50A accordingly.

In some embodiments, video sequence 50A may include one or more scenes. The term ‘scene’ may be used herein to refer to a section of a movie, or a series of movie frames, or a sequence of continuous action, which form single shot of a camera, that may be characterized by specific audiovisual elements, including for example: a background scenery, an angle of photography, lighting, a background narration, and the like.

In some embodiments, user input 50D may include a setting of at least one segmentation criterion as segmentation according to scenes. A respective extracted feature may be an identification of a transition between scenes. For example, embodiments may be configured to segment or divide video sequence 50A to a first scene (e.g., that of an instructor's face during explanation) and a second scene (e.g., that of the instructor working in profile).

Feature extraction module 120 may include an ML-based scene recognition module 20D. Module 20D may include a scene recognition ML model, trained to identify at least one scene from video sequence 50A, as known in the art. For example, module 20D may identify a change in the background scenery pictured in video sequence 50A to determine a transition between scenes (e.g., a change in angle of photography).

In a similar manner to that described above, editor 100 may maintain (e.g., in element 6 of FIG. 1) a table or other data structure associating the extracted features (e.g., the scene transitions) with a respective timestamp of the playing time. In some embodiments, editor 100 may relate to at least one timestamp as a segmentation point in video sequence 50A and may produce a segmented video sequence according to the at least one segmentation point.

In some embodiments, editor 100 may include an ML-based Artificial Intelligence (AI) integration module 30B. AI integration module 30B may receive one or more extracted features of video sequence 50A, from a plurality of feature extraction and data analysis modules, as elaborated above, and at least one criterion for segmenting video sequence 50A and/or visually presenting the visual instructional video.

AI integration module 30B may be trained to integrate the data pertaining to the received one or more extracted features, so as to produce one or more segmentation points according to the at least one received criterion.

Pertaining to the same example of segmenting the table video according to the criterion of segmentation according to stages in the building process, AI integration module 30B may receive (e.g., from storage module 6 of FIG. 1) a plurality of features, including for example: at least one suggestion of a segmentation point according to context from NLP module 30A, associated with a respective timestamp; at least one feature that is a non-verbal sound (e.g., a noise of a machine from module 20A), associated with a respective timestamp; at least one feature that is a change in a scene (e.g., a change in lighting, from module 20D) associated with a respective timestamp; and at least one feature that is a change in a scene (e.g., a change in lighting, from module 20D) associated with a respective timestamp, etc.

AI integration module 30B may identify at least one point in the video playing time that the context, in relation to the predefined segmentation criterion (e.g., a stage in the process of building the table) has changed (e.g., when a stage ends and the table video turns from preparing the legs to the surface). AI integration module 30B may subsequently produce at least one timestamp or segmentation point, marking that change. Editor 100 may subsequently segment video sequence 50A according to the at least one segmentation point as elaborated herein.

Editor 100 may include a scheme production module 150, configured to produce at least one scheme (e.g., element 40 of FIG. 3). Scheme production module 150 may produce scheme 40 as a data structure that may be transferable (e.g., among different instantiations of system 10, as depicted in FIG. 3), and may store or hold data required to present a segmented video sequence on a UI 210 of a player 200.

As elaborated above, editor 100 may extract one or more features from video sequence 50A and associate each extracted feature with a timestamp of the video's playing time. For example, editor 100 may identify an object that appears in the video and associate it with the time of its appearance in the video. Scheme 40 may include one or more such scene timestamps and/or segmentation points 410A, and one or more respective extracted features.

Pertaining to the example of the visual instructional video for building a table, the respective extracted features may include at least one data element (e.g., a textual phrase, such as a word or a sentence) associated with or describing an extracted feature, for example: a product 410E (e.g., ‘table’); a stage or task in the process 410F (e.g., “preparing the legs”, “painting the surface”); a tool and/or ingredient 410G (e.g., ‘saw’, ‘hammer’, ‘brush’, ‘paint’); a scene 410F (e.g., “scene 1”, “scene 2”,“scene 3”), and the like.

In some embodiments, a user may input (e.g., via user input 50D, via UI 110) data relating to the real-world duration of at least one stage or task (e.g., the time it takes to paint the table surface, until the paint is dry). Scheme production module 150 may include in scheme 40 at least one real-world timestamp, associated with the input real-world duration. Player UI 210 may, in turn, present the video alongside a real-world timescale, as elaborated herein.

In some embodiments, a user may input (e.g., via user input 50D, via UI 110) at least one textual comment associated with at least one extracted feature and a respective playing-time timestamp. For example, a user may add a comment, such as “This is the hard part”, and associate it with a respective extracted feature (e.g., a scene in the visual instructional video) and a respective timestamp (e.g., when that scene is presented in the video playing time). Scheme production module 150 may include in scheme 40 the at least one textual comment 410H, and player UI 210 may, in turn, present the comment at the associated timestamp.

According to some embodiments of the invention, editor 100 (e.g., computing module 140 of editor 100) may segment the video sequence (e.g., 50A, 50B and/or 50C) according to the at least one extracted feature (e.g., according to a timestamp or segmentation point as elaborated above), to produce segmented video sequence 70.

For example, segmented video sequence 70 may be a data structure that may include at least one input video sequence 50A, and one or more timestamps or segmentation points, produced according to at least one segmentation criterion. Alternately, or additionally, segmented video sequence 70 may include one or more separate video sequences (e.g., different segments or parts of video sequence 50A). Editor 110 may store (e.g., in storage module 6 of FIG. 1, on an online storage server, and the like) the segments as separate video sequences. Scheme production module may produce a scheme 40 that may include at least one reference or pointer 410B to at least one stored segment (e.g., an address of storage on an online server). In such embodiments, player 200 may enable a user to click or select (e.g., via player UI 210) at least one reference or pointer thumbnail on UI 210. UI 210 may consequently present the selected video segment by addressing and reading the content of the location of the stored segment.

In some embodiments, scheme production module may produce a scheme 40 that may include one or more graphic representation 410D (e.g., a thumbnail, an icon and the like) of at least one extracted feature of video 50A having a respective timestamp. For example, the at least one extracted feature may be a change in a scene that may have been identified by scene recognition module 20D and may be associated with a timestamp representing the time at which the change occurred in the video sequence. The respective graphical representation of the extracted feature may, in this example, be a thumbnail image of the first frame of the new scene. Player UI 210 may be configured to present the one or more graphic representations 410D and enable a user to select or click one of them. Upon such selection, player UI 210 may display the segmented video from the respective timestamp.

According to some embodiments, graphic representations 410D may be unrelated to segmented video sequence 70. For example, UI 110 may enable a user to input (e.g., via input element 7 of FIG. 1) at least one data element, including for example: a video file, a segmented video, a segment of a segmented video, a data file (e.g., a file associated with a specific software application), a text file, an image file, an audio file and the like.

Scheme production module may produce a scheme 40 that may include at least one reference or pointer 410B to the input data element (e.g., an address of storage on an online server where the input data element may be stored).

Scheme production module may produce at least one graphic representation 410D that corresponds with the input data element, including for example, an icon, a thumbnail, a link and the like, as known in the art.

For example, the input data element may be a data file associated with a specific software application, and the graphic representation may be a respective icon of the software application. In another example, the input data element may be a video file, and the graphic representation may be an image thumbnail of a first frame of the video file.

Player 200 may present the one or more graphic representations 410D (e.g., via UI 210) and enable a user to select or click one of them. Upon such selection, player UI 210 may display or open input data element by addressing and reading the content of the location of the stored segment.

In some embodiments scheme 40 may facilitate collaboration and sharing of information among a plurality of users, in relation to specific graphic representations 410D associated with respective data elements and/or segments of segmented video 70, as elaborated herein.

According to some embodiments, segmented video 80 may include one or more respective graphical representations elements (e.g., element 410D), such as thumbnail screenshots of corresponding segments of the video sequence. In such implementations, segmented video 80 may be presented alongside one or more (e.g., all) respective graphical representations elements 410D on a screen of a user's computing device, via a user interface such as a web browser. Thus, the user may perform a search on the internet (e.g., search for videos via a commercially available web browser) and view a representation of the video sequence 50A in alongside, in conjunction with or together with one or more graphical representations elements 410D (e.g., thumbnails) during the search process. The user may thus be able to ascertain, at first glance, whether all segments of video sequence 50A are relevant to them (e.g., whether all segments accommodate their needs). Pertaining to the example of baking a cake, a user may be able to ascertain, as part of the search process, whether they have all the ingredients of the cake.

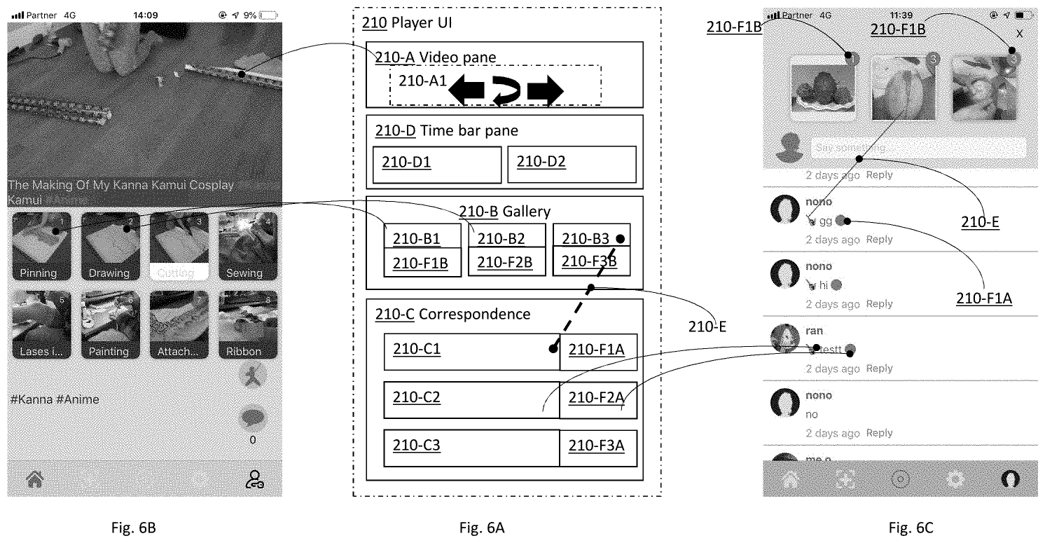

Reference is now made to FIG. 5, which is a block diagram depicting a player module 200 that may be included in a system for presenting a video according to extracted video features, according to some embodiments. Reference is also made to FIG. 6A, which is a block diagram, schematically depicting an example for the appearance of a user interface (e.g., UI 210) on the player side, which may be included in a system for presenting a video according to extracted video features, according to some embodiments. Reference is also made to FIGS. 6B and 6C, which are examples of screen shots of user interface UI 210 that may be included in a system for presenting a video according to extracted video features, and as implemented on a computing device.

As shown in FIG. 5, player module 200 may be or may include at least one computing module 240, configured to execute at least one operation of player module 100, as described herein. In some embodiments, computing module 240 may be implemented as a computing device 1, as elaborated above in relation to FIG. 1.

According to some embodiments, editor 100 may be implemented on a first computing device (e.g., element 10A of FIG. 3) and player 200 may be implemented on a second computing device (e.g., element 10B of FIG. 3). Editor 100 may produce a scheme 40 associated with at least one data element (e.g., a data file, a segmented video sequence, etc.). Scheme 40 may include at least one of a pointer 410B to the data element and a graphical representation 410D of the data element.

UI 110 of editor 100 may enable a user to collaborate or share information relating to the at least one data element with a user of the second computing device, implementing or executing player 200. For example, UI 110 may enable to export or send scheme 40 from editor 100 on the first computing device to player 200 on the second computing device. Player 200 may, in turn, display the at least one data element on UI 210 according to scheme 40.

For example, player module 200 may receive (e.g., from editor module 100) at least one scheme 40 and a respective at least one segmented video sequence 70 and may be configured to display a video on video window or panel 210-A, according to scheme 40 and segmented video sequence 70.

In some embodiments, player module 200 may include a scheme parser module 230 and a video player module 270. Scheme parser module 230 may be adapted to receive scheme 40 from editor 100 and parse the scheme to obtain at least one parsed element 410 (e.g., 410A, through 410H of FIG. 4) of scheme 40. Video player module 270 may receive the at least one element 410 and at least one segmented video sequence 70 and may be configured to display a video on video panel 210-A, according to the at least one element 410 and segmented video sequence 70.

According to some embodiments, player 200 may receive a segmented video sequence 70 and one or more segmentation points 410A (e.g., a timestamp representing the playing time of a border between two segments) associated with respective one or more graphical representations 410D (e.g., a thumbnail image representing the new segment).

Additionally, or alternatively, player 200 may receive an indication or a selection (e.g., from a user of UI 210) of a specific time on a timeline or time bar (e.g., element 210-D of FIG. 6A) as a segmentation point. Player 200 may thus add the newly requested segmentation point to the one or more segmentation points 410A.

Bird's-eye view generator 250 may present the one or more graphical representations 410D as graphical elements 210-B1, 210-B2, 210-B3 (e.g., thumbnails, icons, hyperlink text and the like) on a gallery window or panel 210-B.

UI 210 may enable a user to select a graphical representation 410D (e.g., by clicking a respective graphical representation element, such as 210-B1). Video player module 270 may consequently play segmented video 70 on video panel 210-A from the respective segmentation point 410A. Thus, UI 210 may enable a user to navigate through the visual instructional video according to the extracted features and/or stages of the instructional process.

In a second example, player 200 may receive a segmented video sequence 70 and one or more timestamps 410A (e.g., timestamp representing appearance objects in the video, such as a hammer and a saw) associated with respective one or more graphical representations 410D (e.g., icons of the objects).

Bird's-eye view generator 250 may present the one or more graphical representations 410D as graphical elements 210-B1, 210-B2, 210-B3 (e.g., icons, of a hammer and a saw) on a gallery panel 210-B. UI 210 may enable a user to select a graphical representation 410D (e.g., by clicking a respective icon, such as 210-B2). Video player module 270 may consequently play segmented video 70 on video panel 210-A from the respective timestamp 410A.

The term ‘gallery’ is used herein to refer to a collection of public visual elements, (such as graphical elements 210-B1, 210-B2, 210-B3 that may represent respective data elements including segments of a segmented video), that may be made public by sharing scheme 40 (e.g., by sending or exporting scheme 40 from one user to another).

According to some embodiments, video panel 210-A may include one or more control buttons 210-A1, including for example, a ‘previous’ control button, a ‘next’ control button and a ‘replay’ control button. Player 200 may enable a user to click or select at least one control button 210-A and video panel 210-A may be configured to consequently perform an action according to the user's selection.

For example, when video panel 210-A presents a segment of segmented video 70 that may be associated with a graphical representation element (e.g., 210-B2) in gallery panel 210-B, then: if a user selects the ‘replay’ control button, video panel 210-A may resume the presentation of that segment of segmented video 70 from the start; if a user selects the ‘next’ control button, video panel 210-A may display the video segment that is associated with the next graphical representation element (e.g., 210-B3) in gallery panel 210-B; and if a user selects the ‘previous’ control button, video panel 210-A may display the video segment that is associated with the previous graphical representation element (e.g., 210-B1) in gallery panel 210-B.

According to some embodiments, when video panel 210-A presents a video that may be associated with a respective graphical representation element (e.g., 210-B2) in gallery panel 210-B, the respective graphical representation element (e.g., 210-B2) may be highlighted (e.g., marked by a distinctive color) as shown in FIG. 6B, to visually identify the played video with the graphical representation element (e.g., 210-B2).

As elaborated above, in some embodiments, segmented video 70 may be or may include a data structure including one or more references or pointers to separate segments of input video sequence 50A. In some embodiments, UI 210 may enable a user to select at least one graphical element (e.g., 210-B1) that may be associated with at least one segment of the segmented video and manipulate the segmented video in a segment resolution. For example, UI 210 may enable a user to cut a segment, copy and/or duplicate a segment and paste at least one segment to or from the segmented video sequence.

In a third example, player 200 may receive a segmented video sequence 70 and one or more timestamps 410A associated with respective one or more textual comments 410H. Video player module 270 may visually present segmented video sequence 70 on video panel 210-A (e.g., by presenting an image representing the segmented video sequence) and may include in the presentation the one or more textual comments 410H at the time of the respective one or more timestamps 410A.

In a fourth example, player 200 may receive a product text 410E (e.g., a name or a title of the visual instructional video, such as “preparing ice-cream”), and video player module 270 may include the product name or title in the presentation, e.g., as a top-title, as a cover page, and the like.

As elaborated above, a user may input at least one real-world timestamp 410C, reflecting the progress of time in the real world, for example when a long action is skipped or “fast-forwarded” in the video.

In a fifth example, player 200 may receive a segmented video sequence 70 and an associated scheme including one or more real-world timestamps 410C with respective playing-time timestamps 410A. Video player module 270 may visually present segmented video sequence 70 on video panel 210-A (e.g., by presenting an image representing the segmented video sequence). Real-time display generator 250 may be configured to synchronize the advancement of time on video panel 210-A and in the real world to mark the advance of time in a time bar panel 210-D. In some embodiments time bar panel 210-D may include at least one of: a playing time bar 210-D1, associated with the time lapse of the presented video sequence, showing the advancement of time from the beginning of the video presentation; and a real-world time bar 210-D2, associated with real-world time lapse, and showing the advancement of time in the real world, (e.g., moving faster as long processes such as waiting for a cake to bake are skipped in the production of the visual instructional video).

According to some embodiments, UI 210 may include a correspondence panel 210-C, adapted to input and/or present at least one message (e.g., 210-C1, 210-C2, 210-C3). For example, messages 210-C1, 210-C2 and 210-C3 may be: at least one textual comment that may be input or typed by a user; at least one textual data element that may be input from an input device (e.g., element 7 of FIG. 1); and at least one textual message of correspondence received by computing module 240 from one or more other user and/or computing device (e.g., element 1 of FIG. 1).

In some embodiments, the at least one message (e.g., 210-C1, 210-C2, 210-C3) may be a data structure including, in addition to the textual data, a reference or a pointer to at least one graphical representation 410D. For example, correspondence panel 210-C may enable a user to type a message 210-C1 and select at least one graphical element in the gallery pane 210-B (e.g., a thumbnail 210-B1), associated with a graphical representation 410D that is present in scheme 40.

Correspondence panel 210-C may thus associate the message and the at least one graphical representation 410D. For example, at least one correspondence message or comment 210-C1 may thus be associated with a graphical representation 410D, that may in turn be associated with at least one timestamp or segmentation point of the segmented video.

This association of a message (e.g., 210-C1) to a graphical representation element 410D present in scheme 40 may enable users of different player modules 200 (e.g., on different computing devices) to collaborate in relation to specific elements of the visual instructional video.

For example, users of different player modules 200 may participate in a single discussion (e.g., regarding a process described in a visual instructional video), and comment on different aspects (e.g., stages in the process) of the discussion topic. The aspects may be represented to each of the participating users on their respective player modules 200 as graphical representations (e.g., 210-B1). Each participating user's comment(s) may be also graphically presented by a graphical association element (e.g., 210-E), on the player modules 200 of each user participating in the discussion.

In some embodiments, a plurality of users may use a respective plurality of player modules 200 (e.g., on a plurality of computing devices 1), to send a plurality of messages and/or comments relating to one or more graphical representation elements (e.g., 210-B1). UI 210 may consequently present a graphical association (e.g., 210-E) between graphical representation elements (e.g., 210-B1) and the plurality of comments (e.g., 210-C1, 210-C2, etc.). Thus, the at least one graphical representation element 210-B1 that may relate to a specific data element (e.g., a segment of segmented video 70) may be regarded as public among the one or more users, in a sense that each user may see the graphical association of graphical element 210-B1 with the plurality of associated messages from the plurality of users.

Accordingly, gallery panel 210-B may be regarded as a collection of public graphical representation elements (e.g., 210-B1, 210-B2, 210-B3). Embodiments of the present invention may enable one or more users to collaborate by producing at least one comment, linking the at least one comment to one or more graphical representation elements (e.g., 210-B1, 210-B2) and sharing their comments (e.g., by sending them from one computing device to another). As explained herein, each player 200 may be configured to display the association of each user's comment to the respective graphical representation elements (e.g., 210-B1) to facilitate such collaboration among the users.

For example, a first user may receive a message 210-C1 from a second user, plainly stating “This is fun”. Correspondence panel 210-C may enable the first user to click or select on message 210-C1. Following the selection, correspondence panel 210-C may produce a graphical association 210-E between selected message 210-C1 and a graphical representation (e.g., a thumbnail) 210B-3. As graphical representation (e.g., a thumbnail) 210-B3 is associated with a respective graphical representation element 410D present in scheme 40, which is in turn associated with a data element (e.g., a segment of segmented video 70), the context of the second user's message may be clarified (by graphical association 210-E) as relating to the specific data element (e.g., a stage in a process conveyed by the visual instructional video).

Graphical association 210-E between a message 210-C and graphical representation element (e.g., a thumbnail) 210-B may have any appropriate format as known in the art, to clarify the association. For example, as depicted in FIG. 6, the graphical association may have the form of a line 210-E connecting between elements 210-C1 and 210-B3. In another example, the graphical association may have the form of an indicator 210-F (e.g., 210-F1A, 210-F1B, 210-F2A, 210-F2B, 210-F3A, 210-F3B) having a specific property. For example, indicators 210-F1A and 210-F1B may be ‘LED’ indicator, having a specific color. Indicator 210-F1A may be associated with message element 210-C1 and indicator 210-F1B may be associated with a graphical representation 210-B1 of a data element (e.g., a segment of segmented video 70). Elements 210-C1 and 210-B1 may be graphically associated by presenting the same property on both indicators 210-F1A and 210-F1B. For example, indicators 210-F1A and 210-F1B may be highlighted with the same color.

In some embodiments, indicator 210-F may be used to indicate whether a message 210-C is associated with any graphical representation element 210-B. For example, if such association does not exist, then indicators 210-F1A and 210-F1B may be greyed-out. If such association exists, then indicators 210-F1A and 210-F1B may be highlighted by a specific color. If one or more messages are associated with representation element 210-B, then 210-F1B may include a numerical representation (e.g., 1, 2, 3 etc.) of the number of associated messages.

According to some embodiments, the graphical association may also work the other way around, e.g. to associate graphical representation 210-B and one or more messages 210-C. For example, UI 210 may enable a user to select a graphical representation 210-B of a data element.

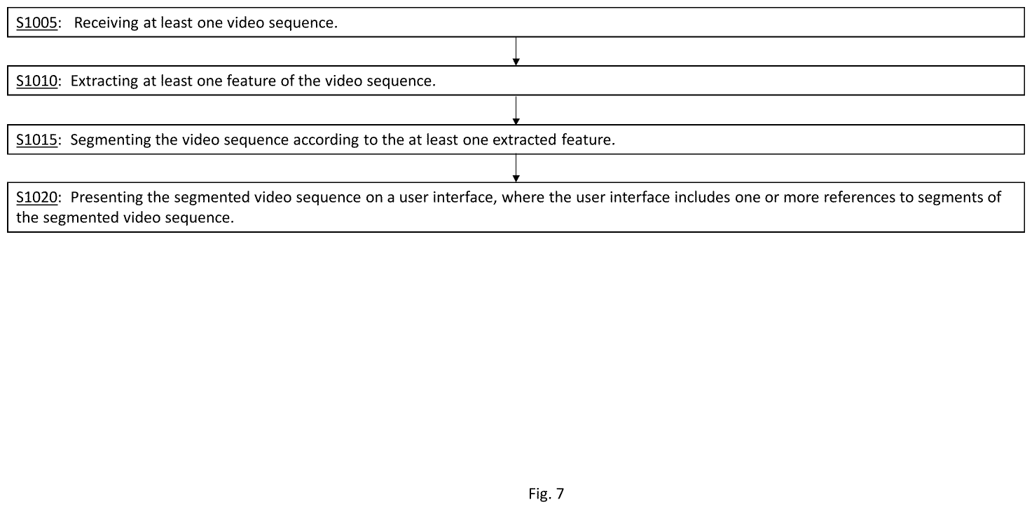

Reference is now made to FIG. 7, which is a flow diagram depicting stages of a method for presenting a video (e.g., a visual instructional video sequence) according to extracted video features, as implemented by elements of system 10, according to some embodiments.

As shown in step S1005, the at least one processor (e.g., element 2 of FIG. 1) of system 10 may receive (e.g., via input device 7 of FIG. 1) at least one video sequence 50A.

As shown in step S1010, the at least one processor 2 may extract at least one feature of the video sequence. For example, processor 2 may receive at least one segmentation criterion (e.g., for segmenting a video sequence according to stages in a procedure that is described in the video), and may extract features corresponding with the at least one segmentation criterion (e.g., one or more stages or tasks included in the video sequence)

As shown in step S1015, the at least one processor 2 may segment the video sequence 50A according to the at least one extracted feature. In some embodiments, processor 2 may produce at least one of a segmented video 70 and a scheme 40, as elaborated herein.

As shown in step S1020, the at least one processor 2 may present the segmented video sequence on a UI (e.g., element 210 of FIG. 5). The UI may include one or more references to segments of the segmented video sequence. For example, UI may include a public gallery panel (e.g., element 210-B of FIG. 6A), that may include one or more graphical representations, such as icons, thumbnails, and the like, each referring to a segment of the segmented video sequence.

Embodiments of the invention present a number of improvements over prior art in the technology of handling of video files, and more specifically in the technology of handling or processing a video sequence of a process that may including one or more discrete portions or stages, such as visual instructional videos.

For example, embodiments may segment or divide the video sequence according to a plurality of predefined criteria, such as different features included in the video, different stages in the process, etc. Furthermore, embodiments may present an overall bird's-eye view of the process according to the video segments and enable a user to access each segment separately. The bird's-eye view presentation may enable a user to: manipulate the segmented video in a segment resolution (including for example: cutting, copying and/or pasting at least one segment or section to or from the segmented video sequence); evaluate, at a first glance, whether the instructed process is suitable for their needs (e.g., whether he or she may have sufficient time or tools to perform all the tasks included in the process conveyed by the visual instructional video); enable a user to share the segmented video among a plurality of other users and/or computing devices; and enabling other users to perform actions such as viewing, commenting on, and saving of one or more segments of the segmented video.

Embodiments of the invention present an improvement over prior art in the technology of online collaboration among a plurality of users. Embodiments may allow a group of two or more users to collaborate through a public gallery, by: producing comments that are linked to specific segments of the video sequence; sharing their comments among a plurality of computing devices; and presenting, on each of the plurality of computing devices an association of each user's comment(s) with specific video sequences, to clarify a context of one or more specific comment(s).

It may be noted that embodiments of the invention present an improvement over prior art in the technology of online collaboration among a plurality of users in relation to data elements that may be unrelated to segmented video sequences. For example, embodiments may allow a group of two or more users to collaborate through the public gallery, by: sharing one or more data elements (e.g., images, data files, etc.) that may not be related to segments of a segmented video; producing comments that may be linked to the one or more data elements; sharing their comments among a plurality of computing devices; and presenting, on each of the plurality of computing devices an association of each user's comment(s) with specific data elements, to clarify a context of one or more specific comment(s).

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A method of segmenting a video sequence by at least one processor, the method comprising:
receiving at least one video sequence;
extracting at least one feature of the video sequence;
segmenting the video sequence according to the at least one extracted feature; and
presenting the segmented video sequence on a user interface (UI), wherein the user interface comprises one or more references to segments of the segmented video sequence.

2. The method of claim 1, wherein the video sequence comprises one or more phrases, and wherein the method further comprises:
obtaining a textual format of at least one phrase in the video sequence; and
segmenting the video sequence according to the obtained textual format of the one or more phrases.

3. The method of claim 2, wherein the phrase is a spoken phrase and wherein the method further comprises:
receiving at least one criterion for segmenting the video sequence;
training a natural language processing (NLP) machine-learning (ML) model to determine at least one segmentation point in the video sequence according to the at least one received criterion and the textual format of at least one phrase in the video sequence; and
segmenting the video sequence according to the determined at least one segmentation point.

4. The method of claim 1, further comprising:
receiving at least one criterion for segmenting the video sequence;
training an object-detection ML model to identify one or more objects in the video sequence;
determining at least one segmentation point according to the identified object and the at least one received criterion; and
segmenting the video sequence according to the determined at least one segmentation point.

5. The method according to claim 1, further comprising:
producing, on a first computing system, a scheme associated with at least one data element;
exporting the scheme to a second computing system; and
displaying the data element on a UI on the second computing system according to the scheme.

6. The method of claim 5, wherein the data element is selected from a list comprising a video file, a segmented video, a segment of a segmented video, a data file, a text file, an image file and an audio file, and wherein the scheme comprises at least one of: a pointer to a storage of the data element and a graphic representation of the data element.

7. The method of claim 1, wherein the UI comprises:
a first panel, comprising at least one video player window;
a second panel, comprising at least one thumbnail referring to a respective segment of the segmented video,
and wherein clicking the at least one thumbnail causes the video player to start displaying the segmented video at the respective segment.

8. The method of claim 7, wherein the UI further comprises at least one of: a first time bar, associated with the time lapse of a video sequence in the at least one video player; and
a second time bar associated with real-world time lapse.

9. The method of claim 7, wherein the UI further comprises a correspondence panel, adapted to comprise at least one of: a correspondence message, received from one or more users and a textual comment.

10. The method of claim 9, wherein at least one of a correspondence message and a comment relates to at least one data element, and wherein the data element is selected from a list consisting of a video file, a segmented video, a segment of a segmented video, a data file, a text file, an image file and an audio file, and wherein the correspondence panel comprises a graphical association of the message or comment to a graphical representation of the related data element.

11. The method of claim 1, further comprising:
receiving, via the UI, at least one request of a user to segment the video sequence at a specific time;
adding a segmentation point according to the request; and
segmenting the video sequence according to the added segmentation point.

12. The method of claim 1, further comprising displaying, on the UI, graphical elements that represent segments of the segmented video as part of a search process on the internet, to enable a user to determine, at first glance whether the video accommodates their needs.

13. A system for segmenting a video file, the system comprising: at least one non-transitory memory device, wherein modules of instruction code are stored, and at least one processor associated with the at least one memory device, and configured to execute the modules of instruction code, whereupon execution of said modules of instruction code, the at least one processor is further configured to:
receive at least one video file;
extract at least one feature of the video file;
segment the video file according to the at least one extracted feature; and
present the segmented video on a UI, wherein the UI comprises one or more references to segments of the segmented video.

14. The system of claim 13, wherein the video sequence comprises one or more phrases, and wherein the at least one processor is further configured to:
obtain a textual format of at least one phrase in the video sequence; and
segment the video sequence according to the obtained textual format of the at least one phrase.

15. The system of claim 14, wherein the at least one phrase is a spoken phrase and wherein the system further comprises an NLP ML model, trained to determine at least one segmentation point in the video sequence according to at least one received segmentation criterion and according to the textual format of at least one phrase in the video sequence, and wherein the at least one processor is further configured to segment the video sequence according to the at least one determined segmentation point.

16. The system of claim 13, wherein the at least one processor is further configured to:
receive at least one segmentation criterion;
train an object-detection ML model to identify one or more objects in the video sequence;
determine at least one segmentation point according to the identified object and the at least one received criterion; and
segment the video sequence according to the determined at least one segmentation point.

17. The system of claim 13, wherein at least one first processor is configured to: produce, on a first computing system, a scheme associated with at least one data element; and export the scheme to a second computing system, and wherein at least one second processor is configured to display the data element on a UI on the second computing system according to the scheme.

18. The system of claim 17, wherein the data element is selected from a list comprising a video file, a segmented video, a segment of a segmented video, a data file, a text file, an image file and an audio file, and wherein the scheme comprises at least one of: a pointer to a storage of the data element and a graphic representation of the data element.

19. The system of claim 13, wherein the UI comprises:
a first panel, comprising at least one video player window;
a second panel, comprising at least one thumbnail referring to a respective segment of the segmented video, wherein clicking the at least one thumbnail causes the video player to start displaying the segmented video at the respective segment.

20. The system of claim 19, wherein the UI further comprises at least one of: a first time bar, associated with the time lapse of a video sequence in the at least one video player and a second time bar associated with real-world time lapse.

21. The system of claim 19, wherein the UI further comprises a correspondence panel, comprising at least one of: a correspondence message received from one or more users and a textual comment.

22. The system of claim 21, wherein at least one of a correspondence message and a comment relates to at least one data element, and wherein the data element is selected from a list comprising a video file, a segmented video, a segment of a segmented video, a data file, a text file, an image file and an audio file, and wherein the correspondence panel comprises a graphical association of the at least one of a correspondence message and a comment to a graphical representation of the related data element.

23. A method of presenting a video sequence on a UI, by at least one processor, the method comprising:
receiving at least one video;
dividing the video according to at least one feature of the video sequence;
producing a graphical representation presenting sections of the video sequence; and
presenting, on a web browser, a representation of the video together with elements of the graphical representation, so as to enable a user to ascertain a relevance of all segments of the video sequence.
